(19) United States
(12) Patent Application Publication
(10) Pub. No.: US 2006/0176628 A1
(43) Pub. Date: Aug. 10, 2006

(54) Semiconductor integrated circuit device and method of manufacturing the same

(76) Inventors: Hisashi Hasegawa, Chiba-shi (JP); Yoshifumi Yoshida, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/346,827

(22) Filed: Feb. 3, 2006

(30) Foreign Application Priority Data
Feb. 4, 2005 (JP) 2005-029319
Jan. 30, 2006 (JP) 2006-020297

(51) Int. Cl. H02H 9/00

(52) U.S. Cl. 361/56

(57) ABSTRACT

An ESD protection circuit with a reduced area is provided whose ESD protection device protects an internal element against ESD while ensuring sufficient. ESD strength in a power management semiconductor device having a fully depleted SOI device structure and in an analog semiconductor device. An NMOS protection transistor formed on an SOI semiconductor thin film layer is used as the ESD protection device at an output terminal of an internal element that is a fully depleted SOI CMOS formed on a semiconductor thin film layer, especially an NMOS output terminal, while an NMOS protection transistor formed on a semiconductor support substrate is used for input protection of the internal element.

### BACKGROUND OF THE INVENTION

1. Field of the Invention

The present invention relates to a power management semiconductor device and to an analog semiconductor device with a low-voltage operation field effect transistor having a fully depleted SOI device structure.

2. Description of the Related Art

It is common in semiconductor integrated circuit devices that utilize field effect transistors such as N type and P type MOS transistors and resistors made of polycrystalline, silicon or the like to place an input protection device or an output protection device between an internal circuit and an external input/output terminal in order to avoid destruction of internal elements constituting the internal circuit due to an input of excessive current caused by static electricity for example. Examples of an input/output circuit block in a semiconductor integrated circuit device having this type of conventional protection circuit are shown in FIGS. 13A and 13B, FIGS. 14A and 14B, and FIGS. 15A and 15B.

FIGS. 13A and 13B show a CMOS inverter 11, which is constituted of an N type MOS transistor and a P type MOS transistor, as an internal element 10 having CMOS structure. An N type MOS transistor is provided as a protection device 20, respectively, between the CMOS inverter 11 and an input terminal 301, between the CMOS inverter 11 and an output terminal 302, and between a Vdd line 303 and a Vss line 304. The circuit structure of the internal element is expressed as a CMOS inverter 11 for the sake of explanation.

With the structure described above, application of an excessive negative voltage to an input or output terminal, for example, makes the PN junctions of an NMOS transistor serving as protection device 20 forward biased, and causes current to flow into the protective NMOS transistor and thus the protective NMOS transistor protects the internal element. On the other hand, application of an excessive positive voltage causes avalanche breakdown of the PN junctions of an NMOS transistor serving as protection device 20, and current flows into a protective MOS transistor. In this way, excessive current is led directly to the grounded substrate via an input/output protection device and is prevented from flowing into the internal element.

Similar ESD protection mechanisms are employed for input/output protection of NMOS transistor 113 constituting the internal element 10 in FIGS. 14A and 14B and for input/output protection of PMOS transistor 112 constituting the internal element 10 in FIGS. 15A and 15B.

Generally speaking, a device element formed on an SOI (Silicon On Insulator) substrate, which has a semiconductor substrate-buried insulating film-semiconductor layer structure, especially one formed on a thin-film SOI substrate, has poor heat dissipation property and is susceptible to damage by heat generated from excessive current since it is surrounded by the buried insulating film and device isolating films. SOI devices are therefore structurally vulnerable against ESD. Accordingly, an ESD protection device formed on an SOI semiconductor thin film layer is easily broken and various measures are taken to give an SOI device a sufficient ESD immunity.

For instance, to improve the ESD immunity of a semiconductor integrated circuit device in which a CMOS buffer type ESD protection circuit is formed on an SOI substrate as an input protection device for internal elements PNP and NPN diodes are added upstream of the CMOS buffer type ESD protection circuit (see JP 3447372 B (page 6, FIG.2), for example).

JP 04-345064 A (page 9, FIG. 1) and JP 08-181219 A (page 5, FIG. 1), for example, show one of measures to obtain a sufficient ESD immunity in a semiconductor integrated circuit device in which the internal element 10 is formed on an SOI semiconductor thin film layer, while the input protection device is formed on a semiconductor support substrate in an opening made by partially removing semiconductor thin film layer and buried insulating film.

In the case of forming ESD protection devices in a semiconductor thin film layer on an SOI substrate as shown in FIGS. 13B, 14B, and 15B, the protection device has to be large in size or many protection devices are needed in order to obtain sufficient ESD immunity, accordingly increase of chip area caused by increase of protection circuit area results in.

In the case of forming a protection devices on a semiconductor support substrate of an SOI substrate in FIGS. 13A, 14A and 15A, on the other hand, the protection devices can work sufficiently as input protections for internal elements since they have enough ESD immunity by themselves and, thus making it possible to improve the withstand voltage. As to the output protection for internal elements, however, this structure leaves the internal element vulnerable to breakdown because of the following reasons:

An SOI device is usually designed such that ESD noise is led to an ESD protection device before it reaches an internal element when an ESD noise comes in. A trigger voltage at which an ESD protection device on a semiconductor support substrate operates is higher than of an internal element, particularly of an NMOS transistor. When an ESD noise enters from the output terminal 302, the noise flows into the internal element formed on an SOI semiconductor thin film layer, the NMOS transistor, in particular, before the protection device starts operating, and induce parasitic bipolar action to break the internal element.

Consequently an ESD protection device should have a lower operating voltage for ESD protection than the withstanding voltage of internal elements and a reduced area for protection circuit while ensuring sufficient strength against destruction.

### SUMMARY OF THE INVENTION

In order to solve the above problems, the present invention employs the following measures.

(1) According to a first aspect of the present invention, there is provided a semiconductor integrated circuit device comprising:

a CMOS device including a first NMOS transistor and a first PMOS transistor, the MOS transistors being formed on a semiconductor thin film layer of an SOI (Silicon On Insulator) substrate, the SOI substrate including a buried insulating film formed on a semiconductor support substrate, and the semiconductor thin film layer formed on the buried insulating film;

a second NMOS transistor for output protection disposed in semiconductor thin film layer; and

a third NMOS transistor for input protection disposed in an opening on the semiconductor support substrate made by partially removing the semiconductor thin film layer and the buried insulating film of the SOI substrate.

(2) According to a second aspect of the present invention, there is provided a semiconductor integrated circuit device comprising:

a CMOS device including a first NMOS transistor and a first PMOS transistor, the MOS transistors being formed on a semiconductor thin film layer of an SOI (Silicon On Insulator) substrate, the SOI substrate including a buried insulating film formed on a semiconductor support substrate, and the semiconductor thin film layer formed on the buried insulating film;

a resistor;

a second NMOS transistor for output protection disposed in semiconductor thin film layer; and

a third NMOS transistor for input protection disposed in an opening on the semiconductor support substrate made by partially removing the semiconductor thin film layer and the buried insulating film of the SOI substrate.

(3) According to a third aspect of the present invention, there is provided a semiconductor integrated circuit device, wherein the second NMOS transistor for output protection disposed in semiconductor thin film layer is connected to a source or drain of the first NMOS transistor and to a source or drain of the first PMOS transistor, respectively, for output protect of the first NMOS transistor and the first PMOS transistor, and wherein the third NMOS transistor disposed on the semiconductor support substrate is connected to an input terminal for gate input protection.

(4) According to a fourth aspect of the present invention, there is provided a semiconductor integrated circuit device, wherein the second NMOS transistor for output protection disposed in semiconductor thin film layer is connected to a source or drain of the first NMOS transistor for output protect, the source or drain being connected to outside via a terminal, and wherein and the third NMOS transistor disposed on the semiconductor support substrate is connected to an input terminal for gate input protection for of the first NMOS transistor and the first PMOS transistor (5) According to a fifth aspect of the present invention, there is provided a semiconductor integrated circuit device, wherein the first NMOS transistor has an electrode of N type conductivity and the first PMOS transistor has an electrode of P type conductivity, and wherein both the second NMOS transistor and the third NMOS transistor have an electrode of N type conductivity. (6) According to a sixth aspect of the present invention, there is provided a semiconductor integrated circuit device, wherein the first NMOS transistor has an electrode of N type conductivity and the first PMOS transistor has an electrode of P type conductivity, and wherein both the second NMOS transistor and the third NMOS transistor have an electrode of P type conductivity.

(7) According to a seventh aspect of the present invention, there is provided a semiconductor integrated circuit device, in which the N type gate electrode of the first NMOS transistor, the P type gate electrode of the first PMOS transistor, and the gate electrodes of the second and the third NMOS transistors have a polycide structure including a laminated structure of a first polycrystalline silicon and a high-melting point metal silicide.

(8) According to an eighth aspect of the present invention, there is provided a semiconductor integrated circuit device, in which the N type gate electrode of the first NMOS transistor, the P type gate electrode of the first. PMOS transistor, and the gate electrodes of the second and the third NMOS transistors are composed of a first polycrystalline silicon.

(9) According to a ninth aspect of the present invention, there is provided a semiconductor integrated circuit device, in which the resister is composed from a second polycrystalline silicon having a thickness different from that of the first polycrystalline silicon composing the gate electrodes of the first NMOS transistor, the first PMOS transistor, the second NMOS transistor, and the third NMOS transistor.

(10) According to a tenth aspect of the present invention, there is provided a semiconductor integrated circuit device, in which the resistor is composed from a single crystal silicon constituting the semiconductor thin film layer.

(11) According to a eleventh aspect of the present invention, there is provided a semiconductor integrated circuit device, in which the resistor is composed from a thin film metal resistor.

(12) According to a twelfth aspect of the present invention, there is provided a semiconductor integrated circuit device, in which the thin film metal resistor is made from one selected from Ni—Cr alloy, chromium silicide, molybdenum silicide, and β-ferrite silicide.

(13) According to a thirteenth aspect of the present invention, there is provided a semiconductor integrated circuit device, in which the semiconductor thin film layer constituting the SOI substrate has a thickness of 0.05 μm to 0.2 μm.

(14) According to a fourteenth aspect of the present invention, there is provided a semiconductor integrated circuit device, in which the buried insulating film constituting the SOI substrate has a thickness of 0.1 μm to 0.5 μm.

(15) According to a fifteenth aspect of the present invention, there is provided a semiconductor integrated circuit device, in which the buried insulating film constituting the SOI substrate is made from a ceramic.

(16) According to a fifteenth aspect of the present invention, there is provided a semiconductor integrated circuit device, in which the ceramic is provided by one selected from glass, sapphire, silicon oxide and silicon nitride.

(17) According to a seventeenth aspect of the present invention, there is provided a method of manufacturing a semiconductor integrated circuit device comprising: a CMOS device including a first NMOS transistor and a first PMOS transistor, the MOS transistors being formed on a semiconductor thin film layer of an SOI substrate, the SOI substrate including a buried insulating film formed on a semiconductor support substrate, and the semiconductor thin film layer formed on the buried insulating film; a resistor; a second NMOS transistor for output protection disposed in semiconductor thin film layer; and a third NMOS transistor for input protection disposed on the semiconductor support substrates, the method comprising the steps of:

patterning a photoresist on the semiconductor thin film layer in order to form the third NMOS transistor performing input protection on the semiconductor support substrate;

forming an opening to expose the semiconductor support substrate by partially removing the semiconductor thin film layer and the buried insulating film of the SOI substrate by etching;

forming a device isolation insulating film having a thickness thick enough to reach the buried insulating film by thermal oxidization;

forming a gate insulating film by thermal oxidization;

depositing a first polycrystalline silicon on the gate insulating film to a thickness of 500 angstrom to 2500 angstrom;

patterning a photo resist on the first polycrystalline silicon, and doping the first polycrystalline silicon with an impurity to achieve an impurity concentration of 1×10¹⁸ atoms/cm³ or more, to turn the conductivity type of the first polycrystalline silicon partially selectively into N;

patterning a photoresist on the first polycrystalline silicon, and doping the first polycrystalline silicon with an impurity to achieve an impurity concentration of 1×10¹⁸ atoms/cm³ or more, to turn the conductivity type of the first polycrystalline silicon partially selectively into P;

depositing a high-melting point metal silicide on the first polycrystalline silicon to a thickness of 500 angstrom to 2500 angstrom;

forming a gate electrodes by etching the first polycrystalline silicon and the high-melting point metal silicide;

depositing a second polycrystalline silicon on the device isolation insulating film to a thickness of 500 angstrom to 2500 angstrom;

doping the second polycrystalline silicon with an impurity;

etching the second polycrystalline silicon to form the resistor;

patterning a photoresist to make regions that are to serve as sources and drains of the first, second, and third NMOS transistors and partially selectively doping the semiconductor thin film layer and the semiconductor support substrate with the N type impurity;

patterning a photoresist to make regions that are to serve as a source and drain of the first PMOS transistor and partially selectively doping the semiconductor thin film layer and the semiconductor support substrate with the P type impurity;

forming an intermediate insulating film on the SOI substrate;

forming a contact hole in the intermediate insulating film on the SOI substrate;

forming a metal wiring in the contact hole; and

forming a protection film.

(18) According to an eighteenth aspect of the present invention, there is provided a method of manufacturing a semiconductor integrated circuit device, in which isotropic wet etching is employed to remove the buried insulating film after removal of the semiconductor thin film layer.

(19) According to a nineteenth aspect of the present invention, there is provided a method of manufacturing a semiconductor integrated-circuit device, in which anisotropic dry etching is employed to remove the buried insulating film after removal of the semiconductor thin film layer.

(20) According to a twentieth aspect of the present invention, there is provided a method of manufacturing a semiconductor integrated circuit device, in which the buried insulating film is removed halfway by anisotropic dry etching and the remaining buried insulating film is removed by isotropic wet etching after removal of the semiconductor thin film layer.

As described above, in the semiconductor integrated circuit device, using the NMOS protection transistor formed on the SOI semiconductor thin film layer as an ESD protection device for internal elements formed on the semiconductor thin film layer, particularly for NMOS output terminals, while using the NMOS protection transistor formed on the semiconductor support substrate as an input protection for internal elements enable absorption of ESD noise before the internal element, input to and output protection of the internal elements on the semiconductor thin film, which is weak against ESD noise, and reduction of the protection circuit area, while ensuring sufficient ESD strength.

The protection effect is prominent particularly in a power management semiconductor integrated circuit device and an analog semiconductor integrated circuit device in which input/output electric property is important.

### BRIEF DESCRIPTION OF THE DRAWINGS

In the accompanying drawings:

FIG. 1 is a schematic sectional diagram showing a semiconductor integrated circuit device according to an embodiment of the present invention;

FIGS. 2A and 2B are structural diagrams of protection circuits for a CMOS output type internal element according to the present invention;

FIG. 3 is a structural diagram of protection circuits for an NMOS output type internal element according to the present invention;

FIGS. 4A and 4B are structural diagrams of protection circuits for a PMOS output type internal element according to the present invention;

FIG. 5 is a schematic sectional diagram showing a semiconductor integrated circuit device according to another embodiment of the present invention;

FIG. 6 is a schematic sectional diagram showing a semiconductor integrated circuit device according to still another embodiment of the present invention;

FIG. 7 is a schematic sectional diagram showing a semiconductor integrated circuit device according to yet still another embodiment of the present invention;

FIG. 8 is a schematic sectional diagram showing a semiconductor integrated circuit device according to yet still another embodiment of the present invention;

FIG. 9 is a schematic sectional diagram showing a conventional semiconductor integrated circuit device;

FIG. 10 is a schematic sectional diagram showing another conventional semiconductor integrated circuit device;

FIG. 11 is a schematic sectional diagram showing still another conventional semiconductor integrated circuit device;

FIG. 12 is a schematic sectional diagram showing yet still another conventional semiconductor integrated circuit device;

FIGS. 13A and 13B are structural diagrams of conventional protection circuits for a CMOS output type internal element;

FIGS. 14A and 14B are structural diagrams of conventional protection circuits for an NMOS output type internal element;

FIGS. 15A and 15B are structural diagrams of conventional protection circuits for a PMOS output type internal element; and

FIGS. 16 to 28 are sectional diagrams arranged in the order of process steps to show a method of manufacturing a semiconductor integrated circuit device according to an embodiment of the present invention.

### DETAILED DESCRIPTION OF THE PREFERRED EMBODIMENT

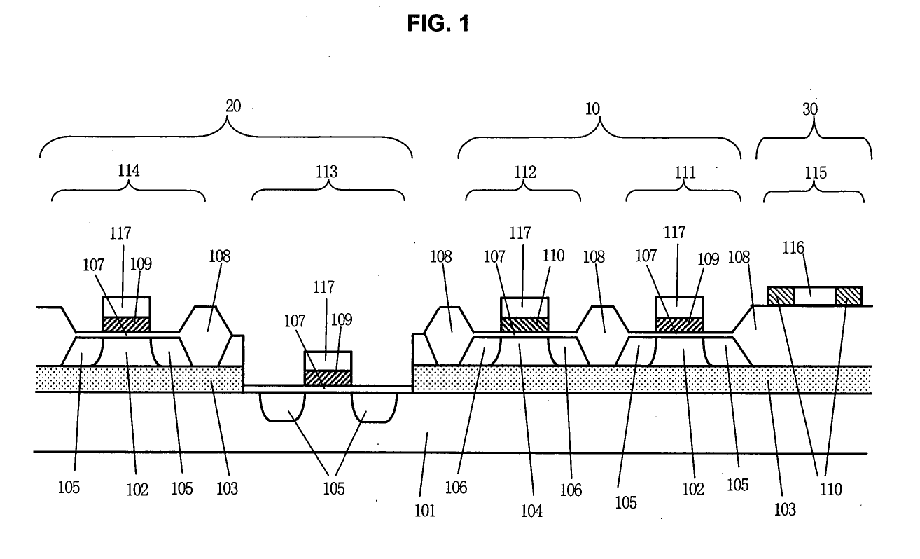

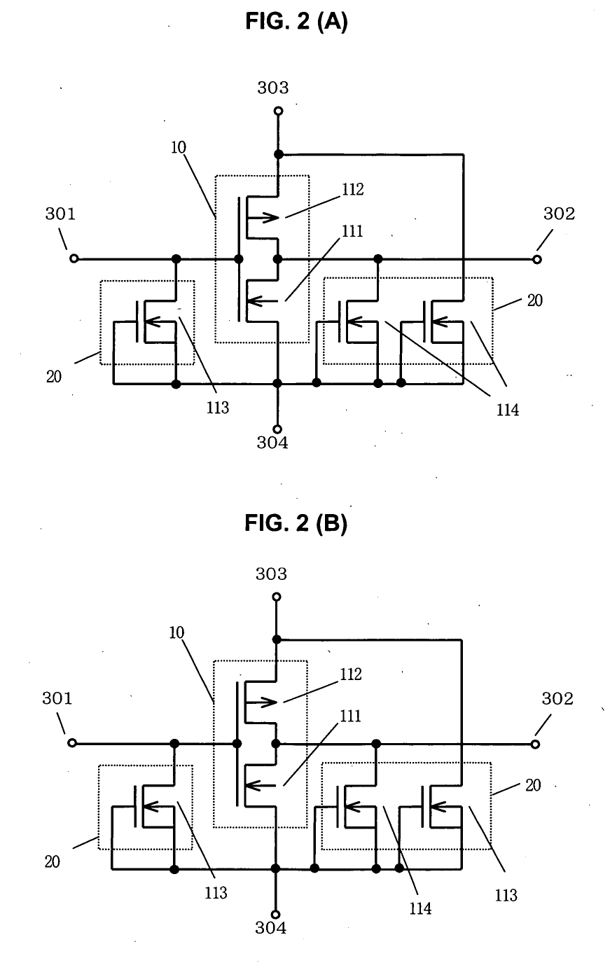

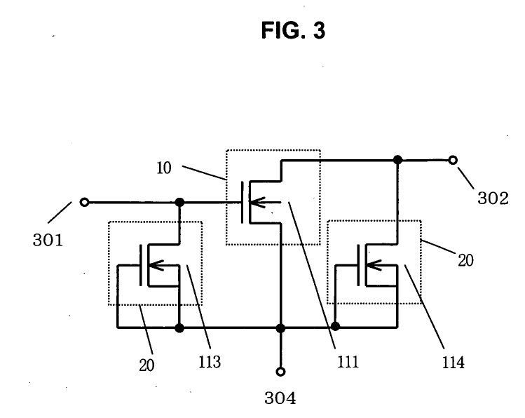

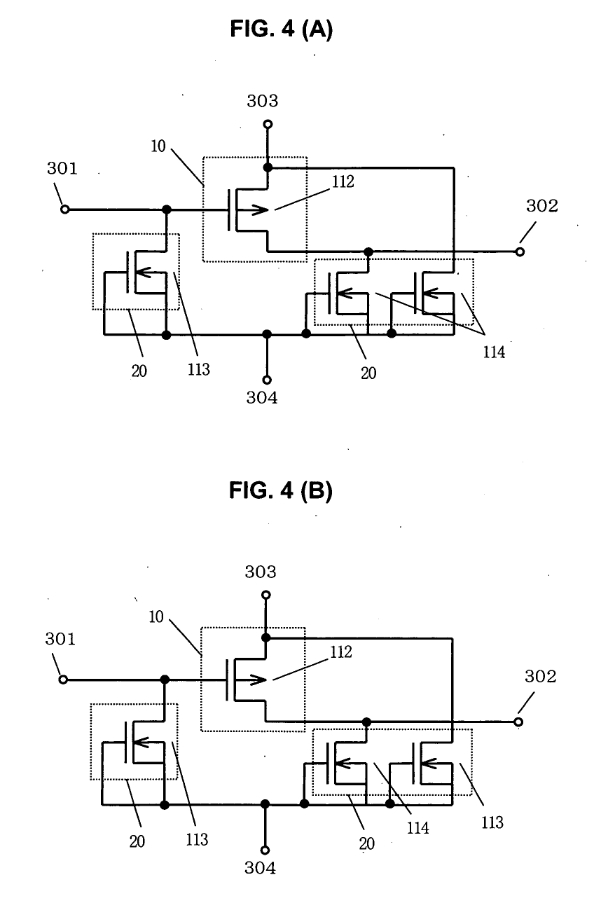

A detailed description will be given below on embodiments of the present invention with reference to the accompanying drawings. FIG. 1 is a schematic sectional view showing an embodiment of a semiconductor integrated circuit device according to the present invention. FIGS. 2A and 2B, FIG. 3, and FIGS. 4A and 4B show protection circuits utilizing internal elements formed in the semiconductor integrated circuit device of FIG. 1.

An SOI substrate in FIG. 1 is composed of: a semiconductor support substrate 101, which is made of, for example, P type single crystal silicon; a buried insulating film 103; and a semiconductor thin film layer 102, which is made of P type single crystal silicon, used to form devices. Formed on the P type semiconductor thin film layer 102 are a CMOS inverter 11 and a P-type conductivity resistor (P-resistor) 115. The CMOS inverter 11 serves as an internal element 10 composed of a first N-channel MOS transistor (hereinafter referred to as NMOS) 111 and a first P-channel MOS transistor (hereinafter referred to as PMOS) 112. The P-resistor 115 is made of polycrystalline silicon and serves as a resistor device 30. The internal element 10 is not limited to the CMOS inverter 11, and various other circuits can serve as the internal element 10.

The semiconductor integrated circuit device shown in FIG. 1 has, as a protection device 20, NMOS ESD protection transistors (hereinafter referred to as NMOS protection transistors) 114 and 113, which are second NMOS transistor formed on the semiconductor thin film layer 102 and the third NMOS transistor formed on the semiconductor support substrate 101, respectively.

The structure of CMOS in thin film SOI devices, in particular, in fully depleted (FD) SOI devices, which have great advantage in low-voltage operation and low-power consumption, is a so-called unipolar gate structure. The CMOS inverter 11 of FIG. 1 has the unipolar gate structure in which a gate electrode of the NMOS transistor 111 is made of N+ polycrystalline silicon 109 and a gate electrode of the PMOS transistor 112 is made of P+ polycrystalline silicon as described below. In the following description an SOI device has the FD structure.. Polycrystalline silicon that is used to form transistor gate electrodes is referred to as the first polycrystalline silicon.

The NMOS transistor 111 is composed of N+ impurity diffusion layers 105, which serve as a source and a drain, disposed on the P type semiconductor thin film layer 102, and a gate electrode, which has a so-called polycide structure. The gate electrode of the NMOS transistor 111 is obtained by depositing the high-melting point metal silicide 117 such as tungsten silicide, molybdenum silicide, titanium silicide, or platinum silicide on the N+ polycrystalline silicon 109, which is deposited on the gate insulating film 107 made of an oxide film or the like. The PMOS transistor 112 is composed of P+ impurity diffusion layers 106 and a polycide structure gate electrode. The P+ impurity diffusion layers 106 serve as a source and a drain disposed on the N type semiconductor thin film layer 104, which is formed in the P type semiconductor thin film layer 102 as an N well. The gate electrode of the PMOS transistor 112 is obtained by depositing the high-melting point silicide 117 and P+ polycrystalline silicon 110 on the gate insulating film 107 made of an oxide film or the like as in the NMOS transistor 111.

The NMOS transistor 111 and the PMOS transistor 112 are completely isolated from each other by the field insulating film 108, which is formed through, for example, LOCOS (Local Oxidation of Silicon) method, and by the buried insulating film 103.

A P− resistor of high resistance, for example, is formed on the field insulating film 108 to serve as the resistor device 30. The resistor device 30 is used for a bleeder voltage divider circuit, which is an analog circuit for divides voltage, or a CR circuit, which generates a time constant. The P− register of this embodiment is formed of polycrystalline silicon.

The NMOS protection transistor 113 constituting the protection device 20 is composed of the N+ impurity diffusion layer 105, which serves as a source and a drain, and a polycide structure gate electrode. The N+ impurity diffusion layer 105 of the NMOS protection transistor 113 is formed on the semiconductor support substrate 101 exposed to the outside by partially removing the semiconductor thin film layer 102 and the buried insulating film 103. The gate electrode of the NMOS protection transistor 113 is obtained by depositing the N+ polycrystalline silicon 109 and the high-melting point silicide 117 on the gate insulating film 107 made of an oxide film or the like as in the NMOS transistor 111 of the internal element 10.

The NMOS protection transistor 114 constituting the protection device 20 is similarly composed of the N+ impurity diffusion layers 105, which serve as a source and a drain on the P type semiconductor thin film layer 102, and a polycide structure gate electrode. The gate electrode of the NMOS protection transistor 114 is obtained by depositing the N+ polycrystalline silicon 109 and the high-melting point silicide 117 on the gate insulating film 107 made of an oxide film or the like.

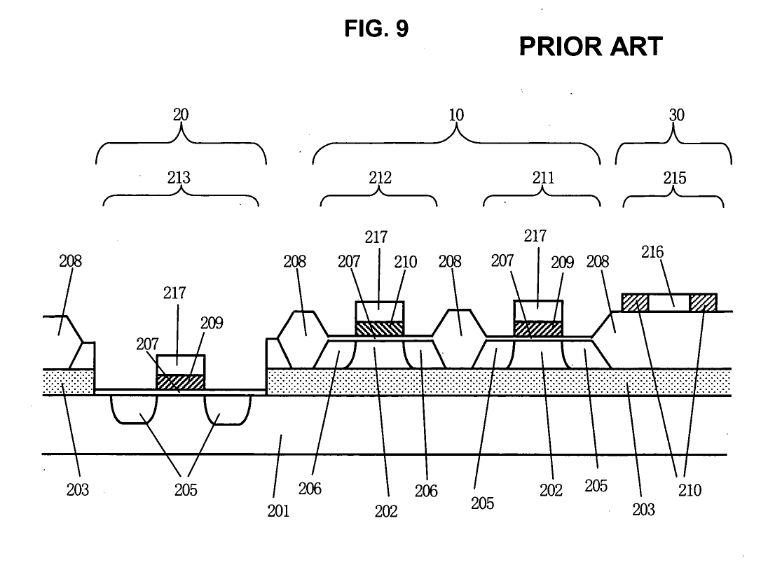

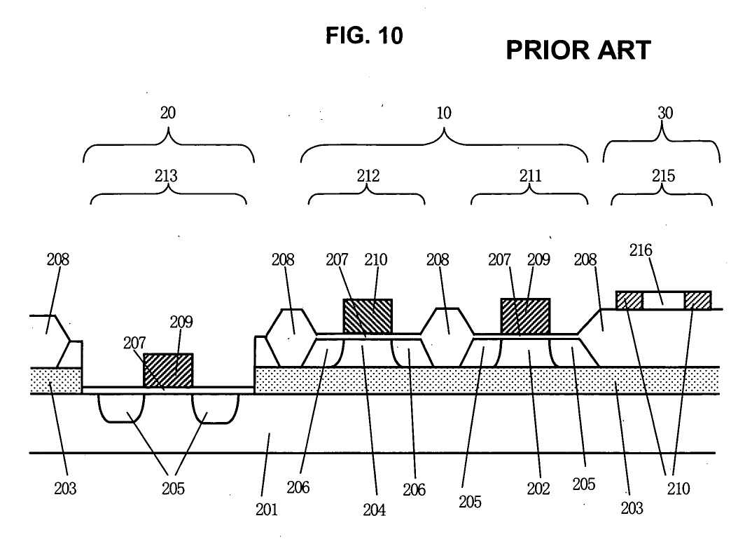

In FIGS. 9 and 10 each of which shows a conventional structure, an ESD protection device 20 consists solely of an NMOS protection transistor 213 formed on a semiconductor support substrate 201, and works as an input/output protection of the internal element 10. The NMOS protection transistor 213 has tolerance to ESD noise, and therefore works sufficiently as an input protection.

As an output protection, snapping back of the NMOS protect-ion transistor has to precede to that of an internal element, in particular that of an NMOS transistor in order to divert an ESD surge. Specifically, trigger voltage (hereinafter referred to as Vtrig) at which an NMOS's snapback characteristic take effect of the NMOS protection transistor has to be lower than that of the NMOS transistor which constitutes an internal element. Hold voltage, which holds parasitic bipolar operation as snap back characteristic (hereinafter referred to as Vhold), of the NMOS protection transistor also has to be lower than that of the NMOS transistor. An NMOS protection transistor that meets these requirements can protect internal elements from ESD noise.

The NMOS transistor 211 which is one of the internal element 10 and which is an FD SOI device has a Vtrig of about 2 V to 8 V and a Vhold of about 2 V to 5 V when the thickness of a semiconductor thin film layer 202 is, for example, 900 angstrom, while the NMOS protection transistor 213 has a Vtrig of about 8 V, at the lowest and a Vhold of about 6 V. Accordingly, when ESD noise enters from an output terminal, there is a possibility that the NMOS protection transistor 213 is not capable of absorbing all of a surge and fails to protect the internal element 10 from the noise-flowing into the internal element 10.

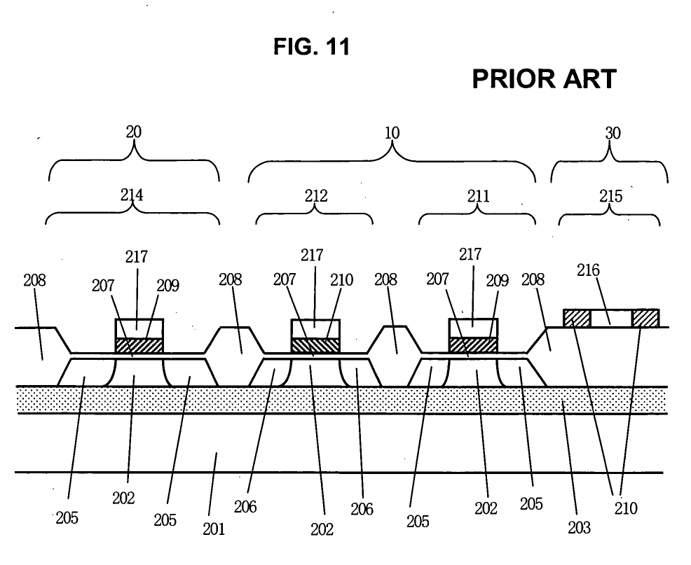

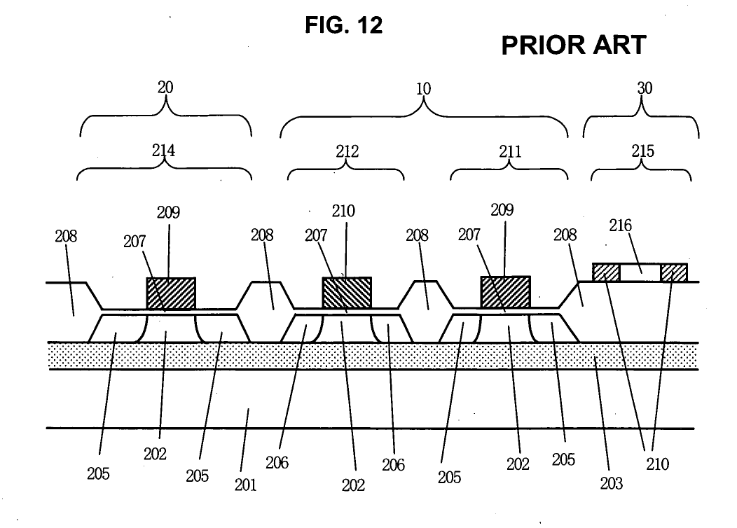

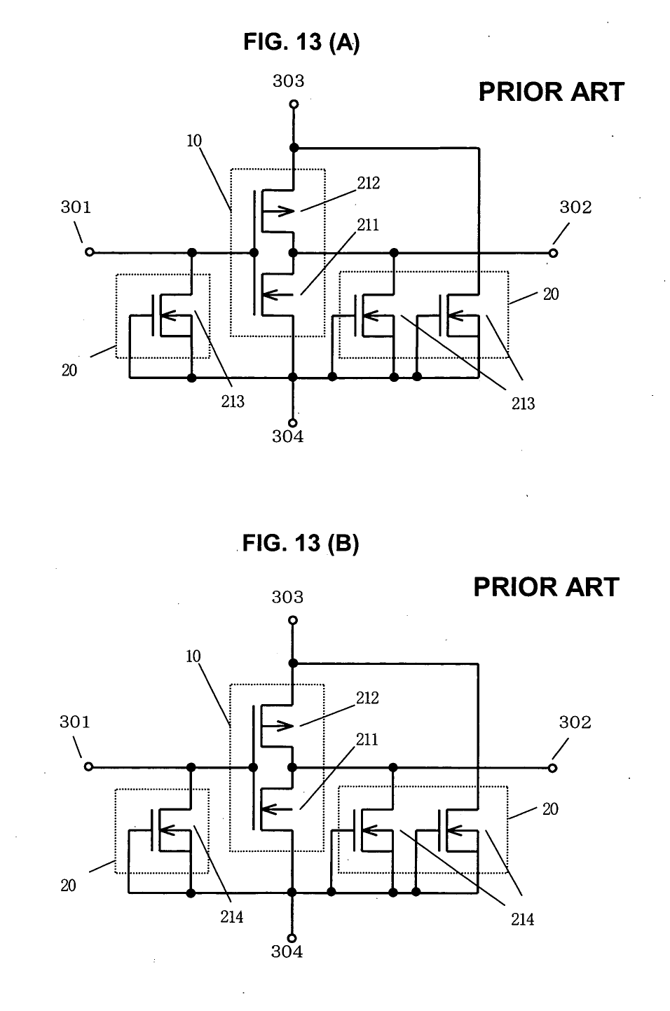

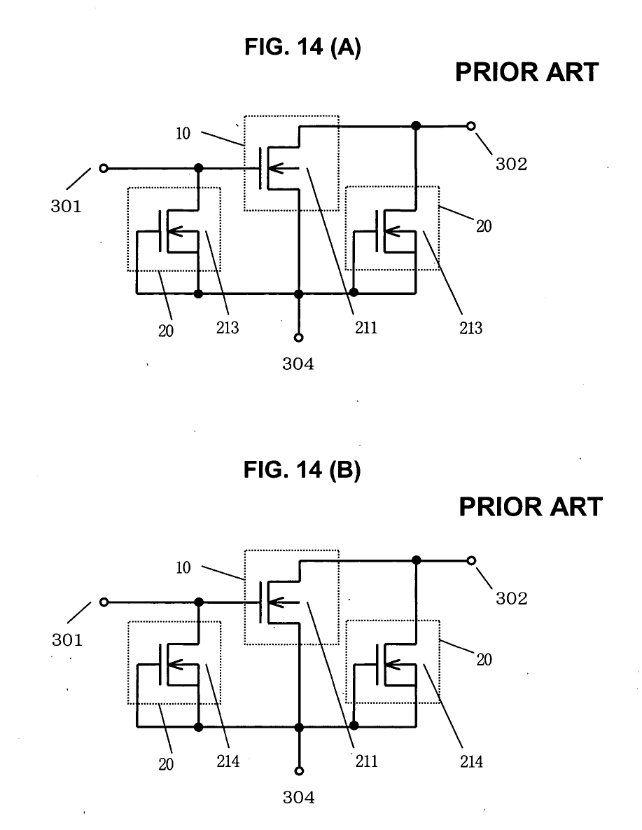

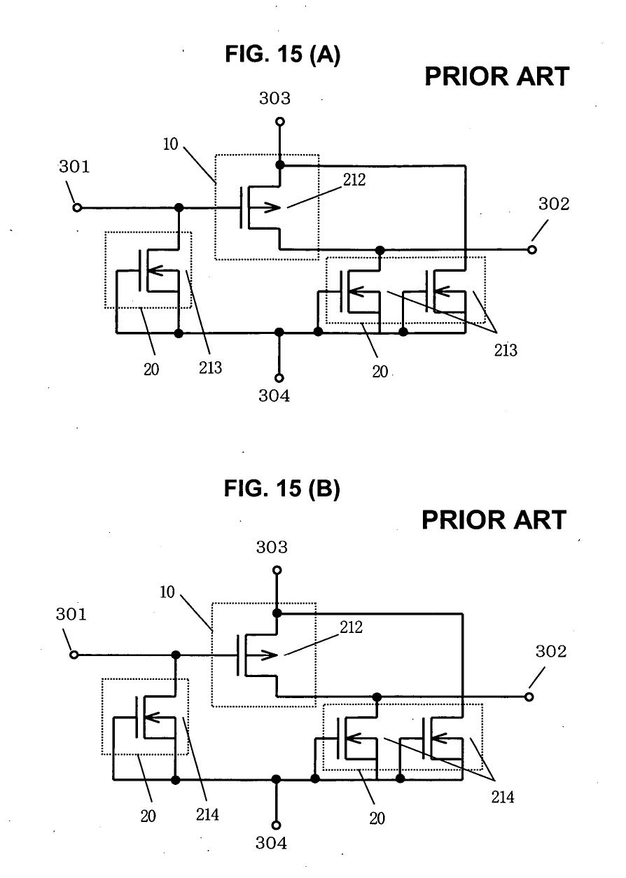

In FIGS. 11 and 12 each of which shows another conventional structure, the ESD protection device 20 consists solely of an NMOS protection transistor 214 formed on a semiconductor thin film layer 202, and works as an input/output protection of the internal element 10. The NMOS protection transistor 214 on the semiconductor thin film is easier than an NMOS protection transistor on a semiconductor support substrate in setting its Vtrig and Vhold lower than the Vtrig and Vhold of an NMOS transistor that constitutes the internal element 10. Accordingly snap back occurs in the NMOS protection transistor 214 earlier than in the NMOS transistor of the internal element 10, and an ESD surge can thus be led to the NMOS protection device.

However, a device formed on a semiconductor thin film layer is surrounded by a buried insulating film 203 and field insulating film 207 for device isolation, and heat tends to linger inside the device, making ESD tolerance of a device on a semiconductor thin film layer far lower than that of a device formed on a semiconductor support substrate or a device on a bulk, and making the device vulnerable to ESD noise. In order to improve the ESD tolerance, the NMOS protection transistor 214 has to have a very large area.

In contrast, the embodiment shown in FIG. 1 employs two NMOS protection transistors 113 and 114 to construct the protection device 20, so that the NMOS protection transistor 113 provides ESD protection for gate input of the internal element 10 and the NMOS protection transistor 114 provides output protection for the internal element 10. By thus using separate devices for input protection and output protection, the internal elements, which are FD SOI devices, can be protected surely both in input and output, and the protection device area can be reduced.

In the embodiment shown in FIG. 1, the N+ impurity diffusion layer 105, which serves as a source and drain of the NMOS transistor 111 constituting the internal element 10, and as sources and drains of the NMOS protection transistors 113 and 114 constituting the protection device 20, is formed of phosphorus or arsenic, and has a concentration of 1×10¹⁹ atoms/cm³ or higher. In forming the N+ impurity diffusion layer 105, the same material can be chosen out of phosphorus and arsenic for all of the NMOS transistor 111 and the NMOS protection transistors 113 and 114. Alternatively, arsenic may be chosen for the NMOS transistor 111 while phosphorus may be chosen for the NMOS protection transistors 113 and 114 to form the N+ impurity diffusion layer 105,.and vice versa. The P+ impurity diffusion layer 106, which serves as a source and drain of the PMOS transistor 112, is formed of boron or BF₂, and has a concentration of 1×10¹⁹ atoms/cm³ or higher.

The N+ polycrystalline silicon 109, which forms N type gate electrodes, contains 1×10¹⁸ atoms/cm³ or higher donor impurity such as phosphorus or arsenic. The P+ polycrystalline silicon 110, which forms P type gate electrodes, contains 1×10¹⁸ atoms/cm³ or higher acceptor impurity such as boron or BF₂. The resistance of the N type and P type gate electrodes is lowered by depositing the high-melting point metal silicide 117, which is tungsten silicide or the like, on the N+ polycrystalline silicon 109 and the P+ polycrystalline silicon 110. The sheet resistance varies depending on the type and thickness of the high-melting point metal silicide 117. Typically, the sheet resistance ranges from ten odd Ω/□ to a few Ω/□ when the high-melting point metal silicide 117 has a thickness from 500 angstrom to 2500 angstrom.

The semiconductor thin film layer 102 and the buried insulating film 103 have thicknesses determined by the operating voltage of the devices formed on the SOI substrate. The buried insulating film 103 is mainly composed of a silicon oxide film, and has a thickness from 0.1 μm to 0.5 μm. Instead, glass, sapphire, a silicon nitride film, or the like may be used to form the buried insulating film 103. The thickness of the semiconductor thin film layer 102 is determined by the function and performance of a fully depleted (FD) SOI device, which is a thin film SOI device, and ranges from 0.05 μm to 0.2 μm.

The embodiment shown in FIG. 1 employs second polycrystalline silicon to form the P− resistor 115 of the resistor device 30, which is used in analog circuit. The P− resistor 115 is formed by a process different from the one used to form the polycrystalline silicon 109 and 110 constituting gate electrodes of the CMOS, and is thinner than the gate electrodes. For instance, when the gate electrodes are 2000 angstrom to 6000 angstrom in thickness, the P− resistor 115 has a thickness of 500 angstrom to 2500 angstrom. This is because, in the case of a resistor made of polycrystalline silicon, a thinner resistor provides higher sheet resistance, better property in temperature, and accordingly improved accuracy. The sheet resistance, which varies depending on the use of a resistor in question, is set within a range of several kΩ/□ to several tens of kΩ/□ in a normal voltage divider circuit. In this range the P− resistor 115 contains boron or BF₂ as an impurity in a concentration of 1×10¹⁴ to 9×10¹⁸ atoms/cm³. Although FIG. 1 shows the P− resistor 115, a P+ resistor of low resistance or an N type resistor which has the reverse impurity polarity may be employed instead when considering resistor properties and demanded product characteristics.

The resistor device 30 may additionally be placed between the input terminal 301 or the output terminal 302 and the internal element 10in FIG. 2, to thereby enhance the protection and resistance against ESD even further.

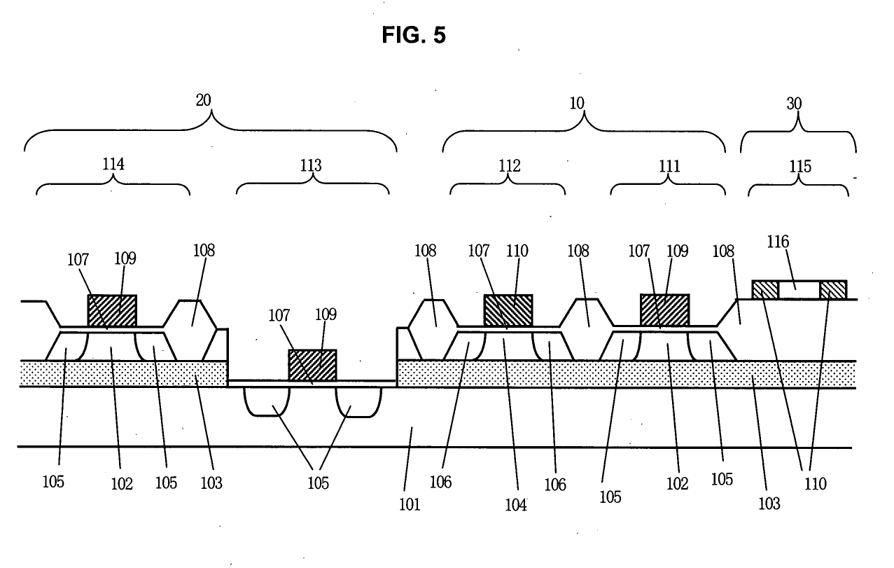

FIG. 5 is a schematic sectional view showing a semiconductor integrated circuit device according to another embodiment of the present invention.

While the embodiment of the present invention that is shown in FIG. 1 employs a laminated polycide structure for gate electrodes, gate electrodes of FIG. 5 where the semiconductor device does not need to operate at high speed nor to accommodate high frequency are formed from a single layer of polycrystalline silicon for the purpose of reducing the number of process steps and cost. Also in this case, input/output protection of internal elements constructed by FD SOI devices can be ensured and constructing the protection device 20 from the two NMOS protection transistors 113 and 114 can reduce the protection device area.

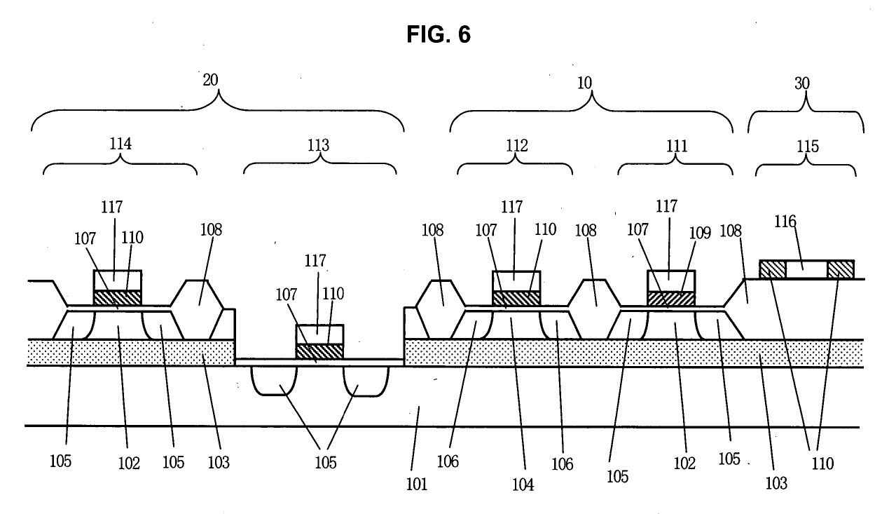

FIG. 6 is a schematic sectional view showing a semiconductor integrated circuit device according to still another embodiment of the present invention. FIG. 6 differs from FIG. 1 in that gate electrodes of the NMOS protection transistors 113 and 114, which constitute the protection device 20, have a polycide structure that is composed of P+ polycrystalline silicon 110 and the high-melting point metal silicide 117 unlike the NMOS transistor 111 of the internal element 10.

The NMOS protection transistors 113 and 114, which are ESD protection devices, are not active devices. Accordingly, in order to reduce the leak current in normal operation, the threshold voltage of the NMOS protection transistors 113 and 114 is set to 1 V or higher by so-called channel doping in which a channel region is doped with an impurity through ion implantation, thus increasing the substrate concentration.

The use of the P+ polycrystalline silicon 110 for gate electrodes of the NMOS protection transistors 113 and 114 as in the embodiment shown in FIG. 6 makes it easy to set, without the channel doping process, the threshold voltage to 1 V or higher because of the work function relation between the gate electrodes and the semiconductor thin film layer. If channel doping is added to this structure, the threshold voltage can be raised further and the gate length of the NMOS protection transistors 113 and 114 can be shortened without the risk of increasing the leak current. This makes it possible to lead ESD noise to the NMOS protection transistors 113 and 114 before it reaches the internal element 10, which is an FD SOI device.

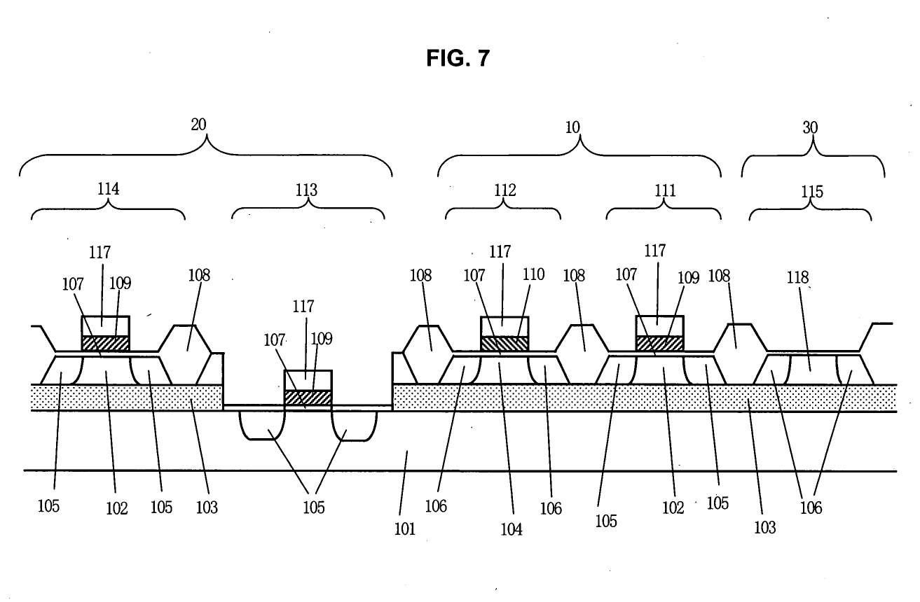

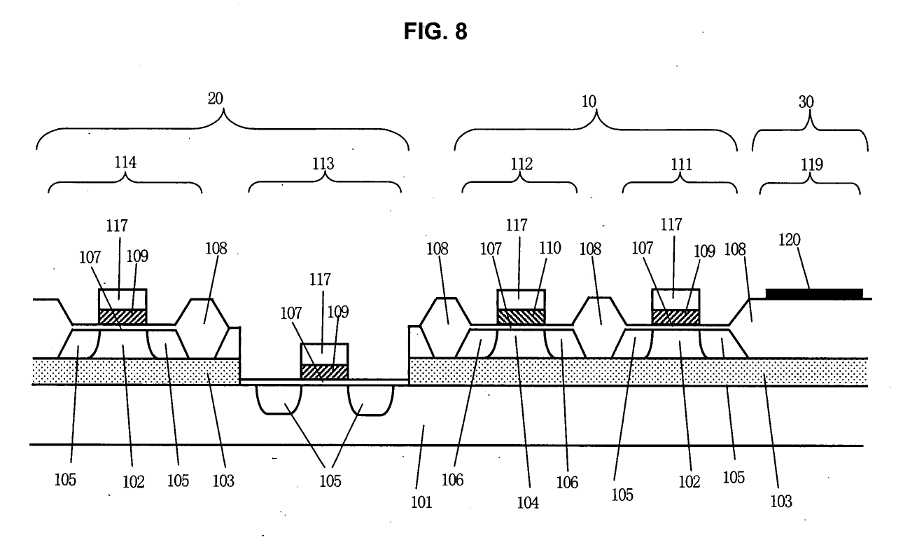

FIGS. 7 and 8 illustrate another structure for the semiconductor integrated circuit device of the present invention that is shown in FIG. 1.

FIG. 7 is a schematic sectional view of another structure for the semiconductor integrated circuit device of the present invention that is shown in FIG. 1.

FIG. 7 also shows as the basic structure of the present invention the CMOS inverter 10, which is an internal element, the protection device 20, which is composed of the NMOS protection transistors 113 and 114 for input/output protection of the internal element against ESD, and the resistor device 30, which is used in an analog circuit. The difference from FIG. 1 is that the resistor device 30 is formed from single crystal silicon of the semiconductor thin film layer instead of polycrystalline silicon as, for example, a P− resistor 118.

In analog circuits, voltage has to be divided with accuracy through a bleeder voltage divider circuit, and high resistance ratio is one of characteristics demanded to bleeder resistors. For instance, in the case of a voltage detector (VD) where the ratio in the area of the resistor circuit 30 to the chip area is very large, improving the accuracy of the resistor device and reducing the resistor device area leads to reduction in chip area as well as cost.

When such a resistor is formed from a semiconductor thin film layer of an SOI substrate that is made of single crystal silicon, the absence of grain boundaries in the resistor prevents resistance fluctuation, which is caused by grain boundaries, and allows the resistor to have high resistance and reduced area. Accordingly, a very effective resistor is obtained.

The semiconductor integrated circuit device according to the embodiment that is shown in FIG. 7 has exactly the same functions and effects as the semiconductor integrated circuit device shown in FIG. 1.

FIG. 8 is a schematic sectional view of still another structure for the semiconductor integrated circuit device of the present invention that is shown in FIG. 1.

FIG. 8 also shows as the basic structure of the present invention the CMOS inverter 10, which is an internal element, the protection device 20, which is composed of the NMOS protection transistors 113 and 114 for input/output protection of the internal element against ESD, and the resistor device 30, which is used in an analog circuit. The difference from FIG. 1 and FIG. 7 is that, as the resistor device 30, a thin film metal resistor 119 is used instead of polycrystalline silicon or single crystal silicon. The embodiment shown in FIG. 8 employs chromium silicide 120 for the thin film metal resistor 119. It is also possible to employ a metal silicide such as a Ni—Cr alloy, molybdenum silicide, or β-ferrite silicide. Chromium silicide has higher resistance compared to other metal suicides and, when formed into a thin film with a thickness of about 100 angstrom to 300 angstrom, can serve as a resistor. Using the thin film metal resistor 119 instead of polycrystalline silicon makes it possible to reduce fluctuation in specific accuracy and resistance, and temperature coefficient as well. The semiconductor integrated circuit device according to the embodiment that is shown in FIG. 8 has exactly the same functions and effects as the semiconductor integrated circuit device shown in FIG. 1.

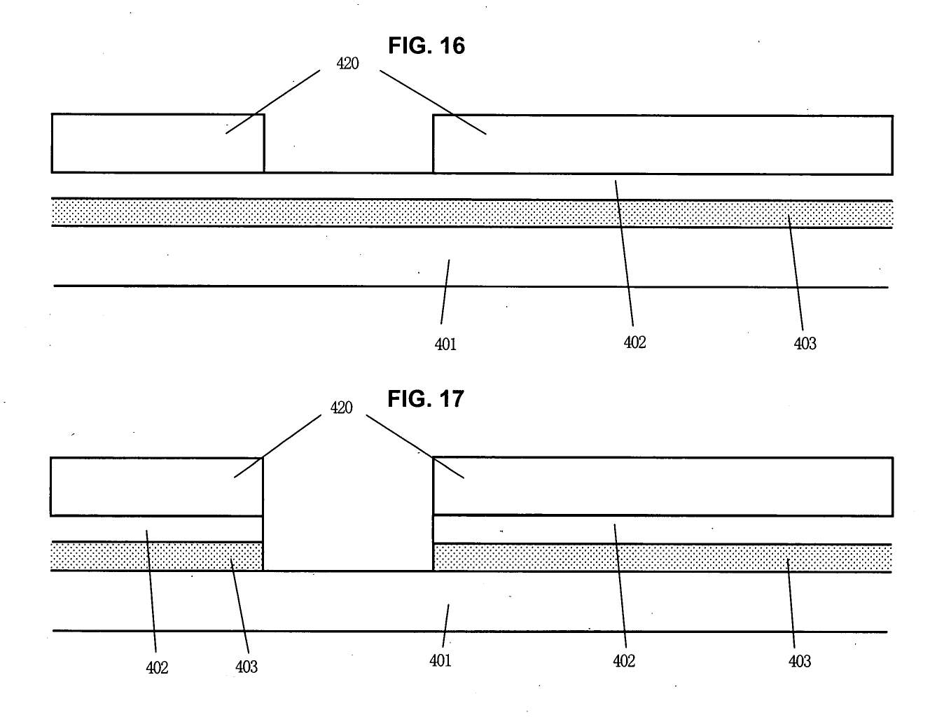

Now, a detailed description is given with reference to FIGS. 16 to 28 on an example of a method of manufacturing the semiconductor integrated circuit device that is shown in FIG. 1.

In FIG. 16, an SOI substrate composed of a P type semiconductor support substrate 401, a buried insulating film 403, and a P type semiconductor thin film layer 402 is coated with photoresist 420. Next performed is patterning of regions on the P type semiconductor support substrate 401 where NMOS protection transistors are to be formed.

With the photoresist 420 as a mask, the P type semiconductor support substrate 402 is etched by RIE anisotropic dry etching until the buried insulating film 403 is exposed. The photoresist 420 is again used as a mask to etch the buried insulating film 403 (FIG. 17). In etching the buried insulating film 403, an etching method can be chosen from, for example, wet etching which uses chemicals, RIE anisotropic dry etching, and a combination of dry etching and wet etching in which a portion of the buried insulating film remaining after dry etching is removed by wet etching. However, in wet etching where a film is etched isotropically, lateral etching takes place in the buried insulating film 403. When the buried insulating film 403 is thick, in particular, the extent of lateral etching is accordingly large and may make undercuts, in the buried insulating film 403. RIE anisotropic dry etching, which gives plasma damage to the P type semiconductor support substrate 401 on which NMOS protection transistors are formed, has a possibility of degradation in characteristics of the NMOS protection transistors. Performing dry etching first and then removing the remaining buried insulating film through wet etching complicates the manufacture process. Weighing their respective advantages and disadvantages, suitable etching methods should be chosen to individual cases.

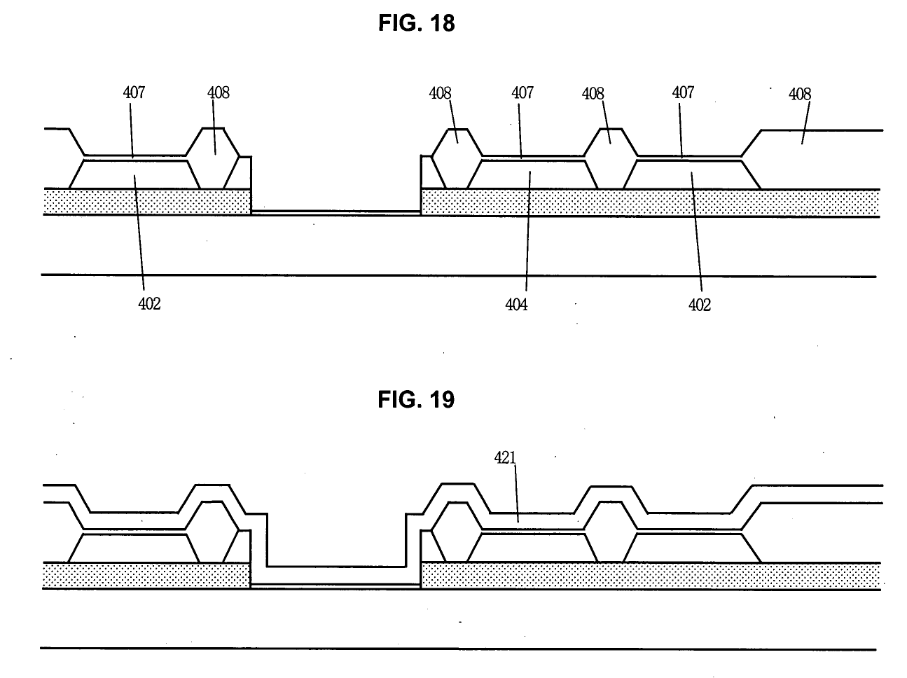

Next, a region of the P type semiconductor thin film layer 402 is doped with, for example, phosphorus through ion implantation, and then subjected to annealing at 1000 to 1175° C. for about 30 minutes to 5 hours to diffuse phosphorus. Thus formed is an N type. semiconductor thin film layer 404 having an impurity concentration of 1×10¹⁶ to 1×10¹⁷ atoms/cm³ for example. Thereafter, as shown in FIG. 18, field insulating film 408 is formed by LOCOS to a thickness that reaches the buried insulating film 403. The field insulating film 408, which in this example is formed after forming the N type semiconductor thin film layer 404, may precede formation of the N type semiconductor thin film layer through ion implantation of phosphorus.

Gate insulating film 407 is then formed by thermal oxidization to a thickness of about 75 angstrom to 300 angstrom. After ion implantation for obtaining a desired threshold voltage, first polycrystalline silicon 421 from which gate electrodes are to be formed are deposited by reduced pressure CVD to a thickness of about 500 angstrom to 2500 angstrom (FIG. 19).

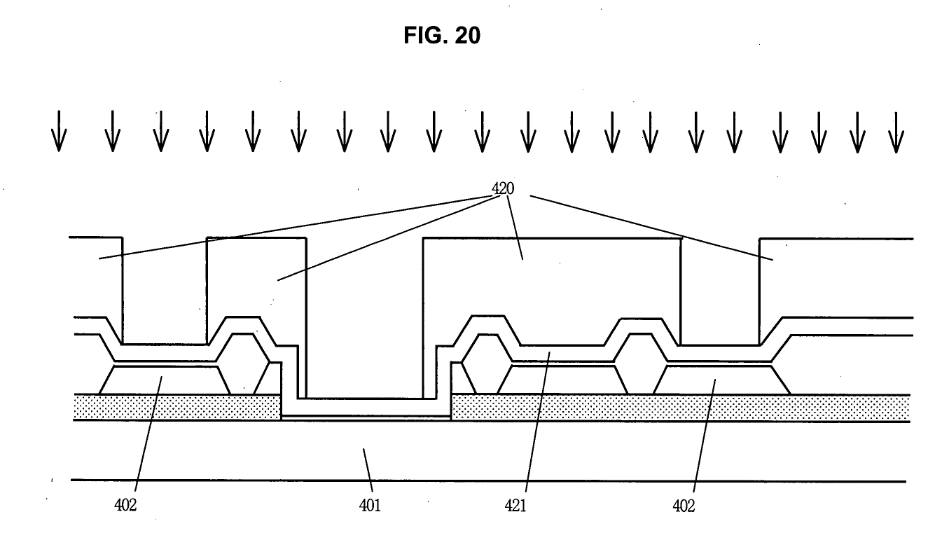

The next step is patterning using the photoresist 420 as shown in FIG. 20. The patterning is performed on regions of the first polycrystalline silicon 421 where N+ polycrystalline silicon is formed as the material of gate electrodes of an NMOS transistor, which is to be formed on the P type semiconductor thin film layer 402, and NMOS protection transistors, which are to be formed on the semiconductor support substrate 401. The regions receive ion implantation of phosphorus or arsenic to have an impurity concentration of 1×10¹⁸ atoms/cm³ or higher.

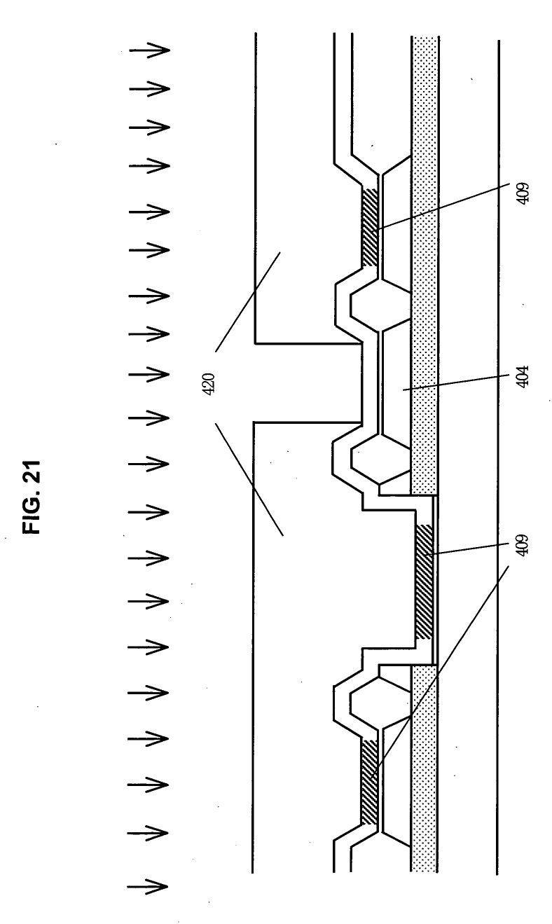

The next step is patterning using the photoresist 420 as shown in FIG. 21. The patterning is performed on a region of the first polycrystalline silicon 421 where P+ polycrystalline silicon is formed as the material of a gate electrode of a PMOS transistor, which is to be formed on the N type semiconductor thin film layer 404. The region receives ion implantation of boron or BF₂ to have an impurity concentration of 1×10¹⁸ atoms/cm³ or higher. The N+ polycrystalline silicon and the P+ polycrystalline silicon, which are formed here by ion implantation, may be formed by introducing impurities such as phosphorus and boron into polycrystalline silicon through pre-depositing.

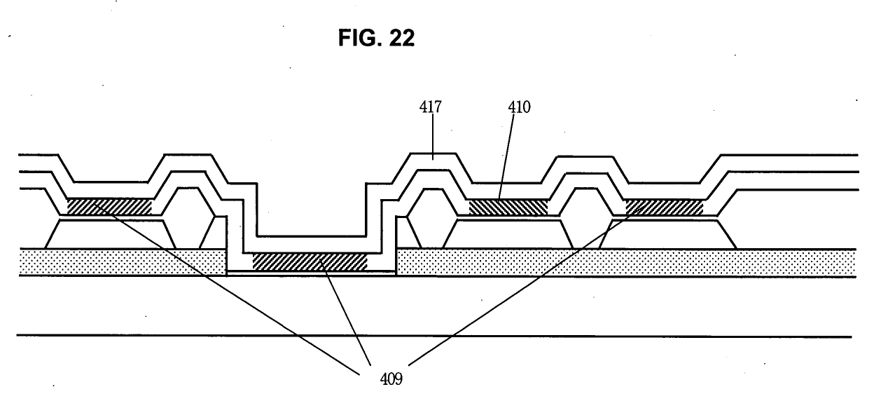

Thereafter, tungsten silicide 417, which is a high-melting point metal silicide, is deposited on the first polycrystalline silicon film by sputtering or the like to a thickness of 500 angstrom to 2500 angstrom. Instead of tungsten silicide used here, molybdenum silicide, titanium silicide, or platinum silicide may be employed as a high-melting point silicide (FIG. 22).

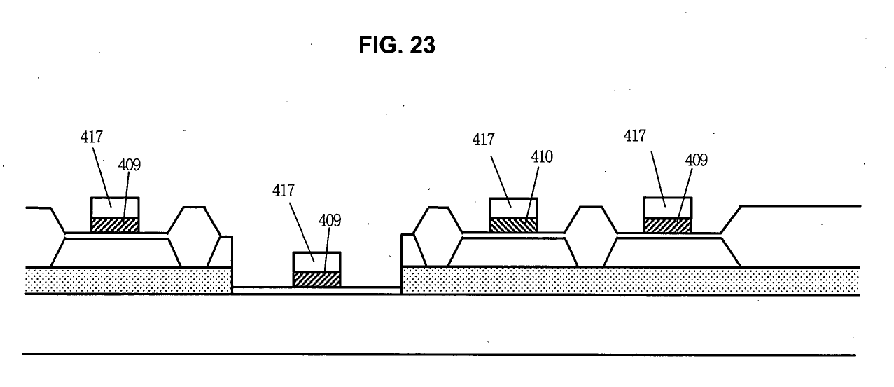

As shown in FIG. 23, after patterning using the photoresist 420, the polycrystalline silicon and the high-melting point silicide are etched to form gate electrodes.

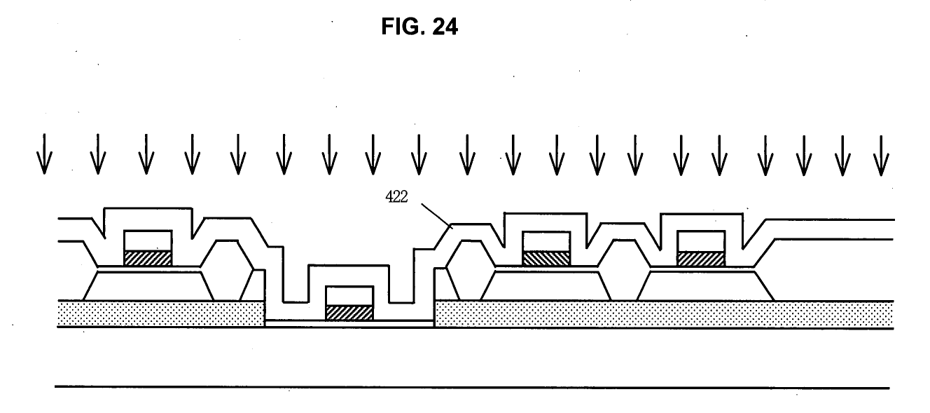

Next, although not shown in the drawings, an oxide film with a thickness of about 100 angstrom to 500 angstrom is formed by thermal oxidization, reduced pressure CVD, or the like on the gate electrode portions and on the surface of the semiconductor substrate. Second polycrystalline silicon 422 is then deposited to a thickness of, for example, 1000 angstrom by using CVD or sputtering as shown in FIG. 24. The entire surface of the second polycrystalline silicon 422 receives ion implantation of BF₂, which is a P type impurity, in a dose of 1×10¹⁴ atoms/cm³, for example, to thereby form a P− resistor of low concentration. BF₂ may be replaced by boron.

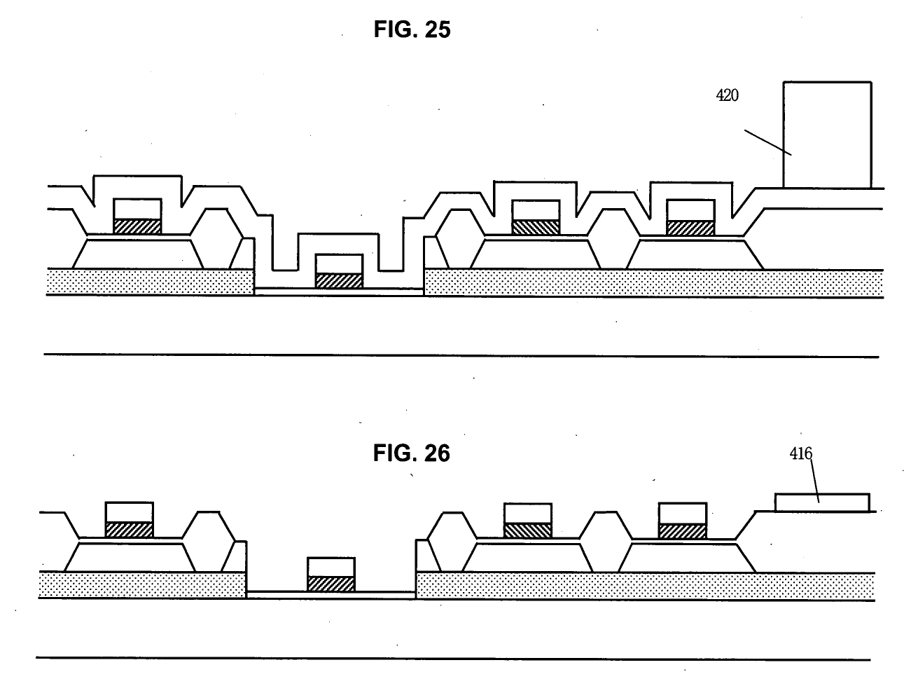

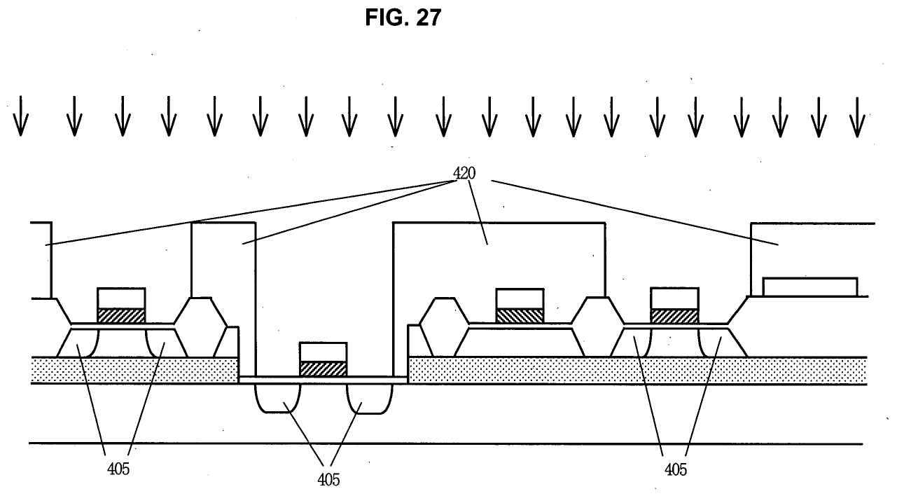

The second polycrystalline silicon 422 is then patterned using the photoresist 420 as shown in FIG. 25 and receives RIE anisotropic dry etching to form a P− resister 416 as shown in FIG. 26.

After the photoresist is removed, new photoresist 420 is patterned as shown in FIG. 27. The patterning is followed by doping of arsenic, which is an N type impurity, through ion implantation in a dose of about 5×10¹⁵ atoms/cm³. Thus formed is an N+ impurity diffusion layer 405, which serves as a source and drain of the NMOS transistor.

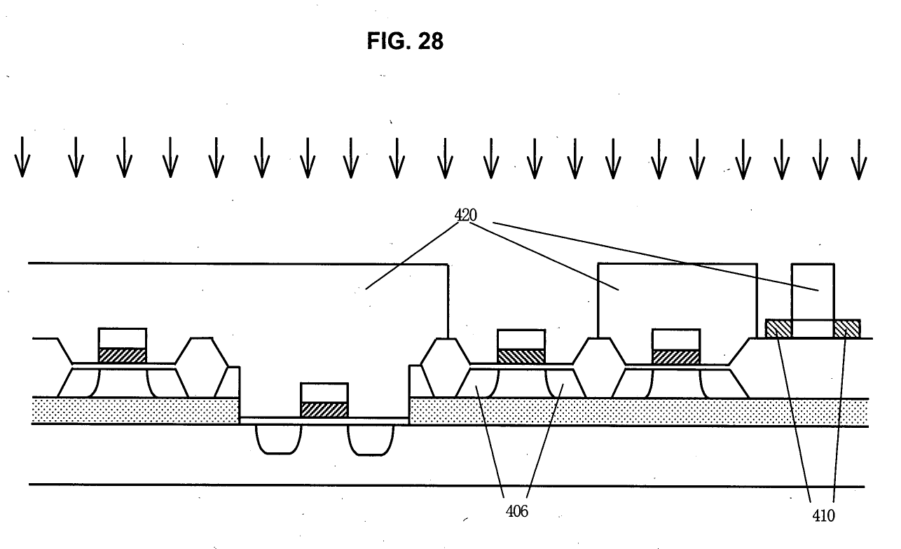

Removal of the current photoresist is again followed by patterning of new photoresist 420 as shown in FIG. 28. Doping of BF₂, which is a P type impurity, is performed through ion implantation in a dose of about 5×10¹⁵ atoms/cm³. Thus formed is a P+ impurity diffusion layer 406, which serves as a source and drain of the PMOS transistor. Simultaneously, P+ polycrystalline silicon 410, which is a P type heavily dosed region, is formed in the P− resister 416 in order to establish satisfactory contact with an aluminum wiring material. Although not illustrated, it is possible to form at this point a P type resistor having a relatively high resistance at 500 Ω to 1000 Ω by doping the entire region of the P− resistor with a P type impurity of high concentration.

The subsequent steps are not illustrated, but are the same as any conventional process of manufacturing a semiconductor integrated circuit device and include formation of an intermediate insulating film, formation of a contact hole, formation of an aluminum wiring pattern, and formation and patterning of a protective film.

Employing an SOI substrate having a P type semiconductor support substrate and a P type semiconductor thin film layer, embodiments of the present invention have been described above. The present invention may instead employ an SOI substrate that has an N type semiconductor support substrate and an N type semiconductor thin film layer. The above description and principle also apply to N substrate P well NMOS protection transistors formed on the N type semiconductor support substrate, and the use of separate devices for input protection and output protection of an internal element ensures input/output protection of the internal element that is an FD SOI device and reduces the protection device area.

The present invention is applicable irrespective of whether an SOI substrate is a bonded SOI substrate, which is obtained by bonding together semiconductor thin films where devices are formed, or a SIMOX substrate, which is obtained by implanting oxygen ion in a semiconductor substrate, performing heat treatment, and forming a buried oxide film. In the case where a bonded SOI is employed, its semiconductor thin film layer and semiconductor substrate may have different conductivity types.

The present invention relates to a power management semiconductor device, or analog semiconductor device, with a low-voltage operation field effect transistor that has a fully depleted SOI device structure and a resistor circuit. Specifically, the present invention relates to a semiconductor integrated circuit device provided with electrostatic discharge damage (ESD) protection devices, and a method of manufacturing the semiconductor integrated circuit device.

What is claimed is:

1. A semiconductor integrated circuit device comprising:
a CMOS device including a first NMOS transistor and a first PMOS transistor, the MOS transistors being formed on a semiconductor thin film layer of an SOI (Silicon On Insulator) substrate, the SOI substrate including a buried insulating film formed on a semiconductor support substrate, and the semiconductor thin film layer formed on the buried insulating film;
a second NMOS transistor for output protection disposed in semiconductor thin film layer; and
a third NMOS transistor for input protection disposed in an opening on the semiconductor support substrate made by partially removing the semiconductor thin film layer and the buried insulating film of the SOI substrate.

2. A semiconductor integrated circuit device according to claim 1, wherein the second NMOS transistor for output protection disposed in the semiconductor thin film layer is connected to a source or drain of the first NMOS transistor and to a source or drain of the first PMOS transistor, respectively, for output protect of the first NMOS transistor and the first PMOS transistor, and wherein the third NMOS transistor disposed on the semiconductor support substrate is connected to an input terminal for gate input protection.

3. A semiconductor integrated circuit device according to claim 1, wherein the second NMOS transistor for output protection disposed in semiconductor thin film layer is connected to a source or drain of the first NMOS transistor for output protect, the source or drain being connected to outside via a terminal; and wherein and the third NMOS transistor disposed on the semiconductor support substrate is connected to an input terminal for gate input protection for of the first NMOS transistor and the first PMOS transistor

4. A semiconductor integrated circuit device according to claim 1, wherein the first NMOS transistor has an electrode of N type conductivity and the first PMOS transistor has an electrode of P type conductivity, and wherein both the second NMOS transistor and the third NMOS transistor have an electrode of N type conductivity.

5. A semiconductor integrated circuit device according to claim 1, wherein the first NMOS transistor has an electrode of N type conductivity and the first PMOS transistor has an electrode of P type conductivity, and wherein both the second NMOS transistor and the third NMOS transistor have an electrode of P type conductivity.

6. A semiconductor integrated circuit device according to claim 1, in which the N type gate electrode of the first NMOS transistor, the P type gate electrode of the first PMOS transistor, and the gate electrodes of the second and the third NMOS transistors have a polycide structure including a laminated structure of a first polycrystailline silicon and a high-melting point metal silicide.

7. A semiconductor integrated circuit device according to claim 1, in which the N type gate electrode of the first NMOS transistor, the P type gate electrode of the first PMOS transistor, and the gate electrodes of the second and the third NMOS transistors are composed of a first polycrystalline silicon.

8. A semiconductor integrated circuit device comprising:
a CMOS device including a first NMOS transistor and a first PMOS transistor, the MOS transistors being formed on a semiconductor thin film layer of an SOI (Silicon On Insulator) substrate, the SOI substrate including a buried insulating film formed on a semiconductor support substrate, and the semiconductor thin film layer formed on the buried insulating film;
a resistor;
a second NMOS transistor for output protection disposed in semiconductor thin film layer; and
a third NMOS transistor for input protection disposed in an opening on the semiconductor support substrate made by partially removing the semiconductor thin film layer and the buried insulating film of the SOI substrate.

9. A semiconductor integrated circuit device according to claim 8, wherein the second NMOS transistor for output protection disposed in the semiconductor thin film layer is connected to a source or drain of the first NMOS transistor and to a source or drain of the first PMOS transistor, respectively, for output protect of the first NMOS transistor and the first PMOS transistor, and wherein the third NMOS transistor disposed on the semiconductor support substrate is connected to an input terminal for gate input protection.

10. A semiconductor integrated circuit device according to claim 8, wherein the second NMOS transistor for output protection disposed in semiconductor thin film layer is connected to a source or drain of the first NMOS transistor for output protect, the source or drain being connected to outside via a terminal, and wherein and the third NMOS transistor disposed on the semiconductor support substrate is connected to an input terminal for gate input protection for of the first NMOS transistor and the first PMOS transistor

11. A semiconductor integrated circuit device according to claim 8, wherein the first NMOS transistor has an electrode of N type conductivity and the first PMOS transistor has an electrode of P type conductivity, and wherein both the second NMOS transistor and the third NMOS transistor have an electrode of N type conductivity.

12. A semiconductor integrated circuit device according to claim 8, wherein the first NMOS transistor has an electrode of N type conductivity and the first PMOS transistor has an electrode of P type conductivity, and wherein both the second NMOS transistor and the third NMOS transistor have an electrode of P type conductivity.

13. A semiconductor integrated circuit device according to claim 8, in which the N type gate electrode of the first NMOS transistor, the P type gate electrode of the first PMOS transistor, and the gate electrodes of the second and the third NMOS transistors have a polycide structure including a laminated structure of a first polycrystalline silicon and a high-melting point metal silicide.

14. A semiconductor integrated circuit device according to claim 8, in which the N type gate electrode of the first NMOS transistor, the P type gate electrode of the first PMOS transistor, and the gate electrodes of the second and the third NMOS transistors are composed of a first polycrystalline silicon.

15. A semiconductor integrated circuit device according to claim 8, in which the resister is composed from a second polycrystalline silicon having a thickness different from that of the first polycrystalline silicon composing the gate electrodes of the first NMOS transistor, the first PMOS transistor, the second NMOS transistor, and the third NMOS transistor.

16. A semiconductor integrated circuit device according to claim 8, in which the resistor is composed from a single crystal silicon constituting the semiconductor thin film layer.

17. A semiconductor integrated circuit device according to claim 8, in which the resistor is composed from a thin film metal resistor, the metal being one selected from Ni—Cr alloy, chromium silicide, molybdenum silicide, and β-ferrite silicide.

18. A semiconductor integrated circuit device according to claim 8, in which the semiconductor thin film layer constituting the SOI substrate has a thickness of 0.05 μm to 0.2 μm, and the buried insulating film constituting the SOI substrate has a thickness of 0.1 μm to 0.5 μm.

19. A method of manufacturing a semiconductor integrated circuit device comprising: a CMOS device including a first NMOS transistor and a first PMOS transistor, the MOS transistors being formed on a semiconductor thin film layer of an SOI substrate, the SOI substrate including a buried insulating film formed on a semiconductor support substrate, and the semiconductor thin film layer formed on the buried insulating film; a resistor; a second NMOS transistor for output protection disposed in semiconductor thin film layer; and a third NMOS transistor for input protection disposed on the semiconductor support substrate, the method comprising the steps of:
patterning a photoresist on the semiconductor thin film layer in order to form the third NMOS transistor performing input protection on the semiconductor support substrate;
forming an opening to expose the semiconductor support substrate by partially removing the semiconductor thin film layer and the buried insulating film of the SOI substrate by etching;
forming a device isolation insulating film having a thickness thick enough to reach the buried insulating film by thermal oxidization;
forming a gate insulating film by thermal oxidization;
depositing a first polycrystalline silicon on the gate insulating film to a thickness of 500 angstrom to 2500 angstrom;
patterning a photoresist on the first polycrystalline silicon, and doping the first polycrystalline silicon with an impurity to achieve an impurity concentration of 1×10¹⁸ atoms/cm³ or more, to turn the conductivity type of the first polycrystalline silicon partially selectively into N;
patterning a photoresist on the first polycrystalline silicon, and doping the first polycrystalline silicon with an impurity to achieve an impurity concentration of 1×10¹⁸ atoms/cm³ or more, to turn the conductivity type of the first polycrystalline silicon partially selectively into P;
depositing a high-melting point metal silicide on the first polycrystalline silicon to a thickness of 500 angstrom to 2500 angstrom;
forming a gate electrodes by etching the first polycrystalline silicon and the high-melting point metal silicide;
depositing a second polycrystalline silicon on the device isolation insulating film to a thickness of 500 angstrom to 2500 angstrom;
doping the second polycrystalline silicon with an impurity;
etching the second polycrystalline silicon to form the resistor;
patterning a photoresist to make regions that are to serve as sources and drains of the first, second, and third NMOS transistors and partially selectively doping the semiconductor thin film layer and the semiconductor support substrate with the N type impurity;
patterning a photoresist to make regions that are to serve as a source and drain of the first PMOS transistor and partially selectively doping the semiconductor thin film layer and the semiconductor support substrate with the P type impurity;
forming an intermediate insulating film on the SOI substrate;
forming a contact hole in the intermediate insulating film on the SOI substrate;
forming a metal wiring in the contact hole; and
forming a protection film.

20. A method of manufacturing a semiconductor integrated circuit device according to claim 19, in which isotropic wet etching is employed to remove the buried insulating film after removal of the semiconductor thin film layer.

21. A method of manufacturing a semiconductor integrated circuit device according to claim 19, in which an isotropic dry etching is employed to remove the buried insulating film after removal of the semiconductor thin film layer.

22. A method of manufacturing a semiconductor integrated circuit device according to claim 19, in which the buried insulating film is removed halfway by anisotropic dry etching and the remaining buried insulating film is removed by isotropic wet etching after removal of the semiconductor thin film layer.
